(19) United States
(12) Patent Application Publication
(10) Pub. No.: US 2011/0055114 A1
(43) Pub. Date: Mar. 3, 2011

(54) Method and System for Electronically Processing Mortgage-Backed Securities

(75) Inventors: Jonathan A. Perez, New York, NY (US); Kevin P. Scherer, New York, NY (US); William A. King, Old Greenwich, CT (US)

(73) Assignee: KCG IP HOLDINGS LLC, Chicago, IL (US)

(21) Appl. No.: 12/821,378

(22) Filed: Jun. 23, 2010

Related U.S. Application Data
(60) Provisional application No. 61/237,113, filed on Aug. 26, 2009.

(51) Int. Cl. G06Q 40/00

(52) U.S. Cl. 705/36 R; 705/35

(57) ABSTRACT

A mortgage-backed securities (MBS) processing system including a processor, a database and a computer-readable memory. The database is configured to store data pertaining to multiple mortgage-backed securities, each mortgage-backed security associated with at least one loan. The computer-readable memory includes computer-readable instructions. When the computer-readable instructions are executed on the processor to associate the multiple mortgage-backed securities stored in the database with a set of different MBS indices based on MBS indexing rules. The MBS indexing rules map a given mortgage-backed security to a given MBS index based at least in part on the credit enhancement type associated with the given mortgage-backed security.

### CROSS-REFERENCE TO RELATED APPLICATIONS

This application claims the benefit of U.S. Provisional Application No. 61/237,113 filed Aug. 26, 2009, and is entirely incorporated by reference herein.

### TECHNICAL FIELD

The present application relates generally to electronic data management and, more specifically, to a method and system for electronically processing mortgage-backed securities.

### BACKGROUND

Mortgage-backed securities (MBS), or MBS deals, are debt obligations that represent claims to the cash flows from pools of mortgage loans, most commonly on residential property. Mortgage loans are purchased from banks, mortgage companies, and other originators and then assembled into pools by a governmental, quasi-governmental, or private entity. The entity then issues securities that represent claims on the principal and interest payments made by borrowers on the loans in the pool, a process known as securitization.

Most MBSs are issued by the Government National Mortgage Association (Ginnie Mae), a U.S. government agency, or the Federal National Mortgage Association (Fannie Mae) and the Federal Home Loan Mortgage Corporation (Freddie Mac), U.S. government-sponsored enterprises. Ginnie Mae, backed by the full faith and credit of the U.S. government, guarantees that investors receive timely payments. Fannie Mae and Freddie Mac also provide certain guarantees and, while not backed by the full faith and credit of the U.S. government, have special authority to borrow from the U.S. Treasury.

Some private institutions, such as brokerage firms, banks, and homebuilders, also securitize mortgages, known as “private-label” mortgage securities, or “non-agency” MBSs. These securities, which are increasingly becoming a major component of the MBS market, are typically issued by homebuilders or financial institutions through subsidiaries and are backed by residential loans that do not conform to the agencies' underwriting standards. Because private-label mortgage securities are not guaranteed by the government agencies, there is generally more risk associated with such mortgage securities. To account for this increase in risk, private-label MBSs are rated by rating agencies and often feature credit enhancements, such as subordination and over collateralization, that are designed to help protect investors from delinquencies. More details regarding the different credit enhancements are provided below.

Mortgage-backed securities exhibit a variety of structures. The most basic types are pass-through participation certificates, which entitle the holder to a pro-rata share of all principal and interest payments made on the pool of loan assets. More complicated MBSs, known as collaterized mortgage obligations or mortgage derivatives, may be designed to protect investors from or expose investors to various types of risk. An important risk with regard to residential mortgages involves prepayments, typically because homeowners refinance when interest rates fall. Absent protection, such prepayments would return principal to investors precisely when their options for reinvesting those funds may be relatively unattractive.

At present, there does not exist an efficient way to organize different MBSs into a common framework, and MBSs are currently processed in an ad-hoc manner, and oftentimes manually. As a result, there are various challenges associated with analyzing the performance of different MBSs, which is currently done in an ad-hoc manner. For instance, there is no efficient way of determining how a given MBS performs relative to similar MBSs. Likewise, it is difficult, at present, to determine how different types of MBSs perform relative to each other.

### BRIEF DESCRIPTION OF THE DRAWINGS

FIG. 1A illustrates an example computer network;

FIG. 1B illustrates an example computer that may be connected to the network of FIG. 1A;

FIG. 2A is a block diagram illustrating an example MBS processing environment;

FIG. 2B is flow diagram illustrating an example method for processing MBSs;

FIG. 3 is a flow diagram illustrating an example method for indexing an MBS;

FIG. 4 is a flow diagram illustration example MBS indexing rules;

FIG. 5 is an example summary of MBS indices resulting from processing MBSs in accordance with indexing rules in FIG. 4;

FIG. 6 is a flow diagram illustrating an example index performance analysis method;

FIG. 7 is an example interface for presenting data regarding MBSs and MBS indices to a user;

FIG. 8 is an example interface for presenting data regarding MBSs and MBS indices to a user;

FIG. 9 is an example interface for presenting BWIC pricing summary to a user;

FIG. 10 is an example interface for presenting details of bonds associated with different MBSs to a user;

FIG. 11 is an example interface for enabling a user to compare the performance of different MBSs and relevant MBS indices;

FIG. 12A is an example interface for presenting a comparison of the performance of different MBSs and relevant MBS indices based on original LTV;

FIG. 12B is an example interface for presenting a comparison of the performance of different MBSs and relevant MBS indices based on effective LTV;

FIG. 13 is an example interface for presenting histogram regarding different MBSs and relevant MBS indices;

FIG. 14 is an example interface for presenting historical data regarding 60+ day delinquencies on loans associated with different MBSs; and

FIG. 15 is an example interface for presenting historical data regarding cumulative losses associated with different MBSs.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the disclosed functionality and many of the disclosed principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

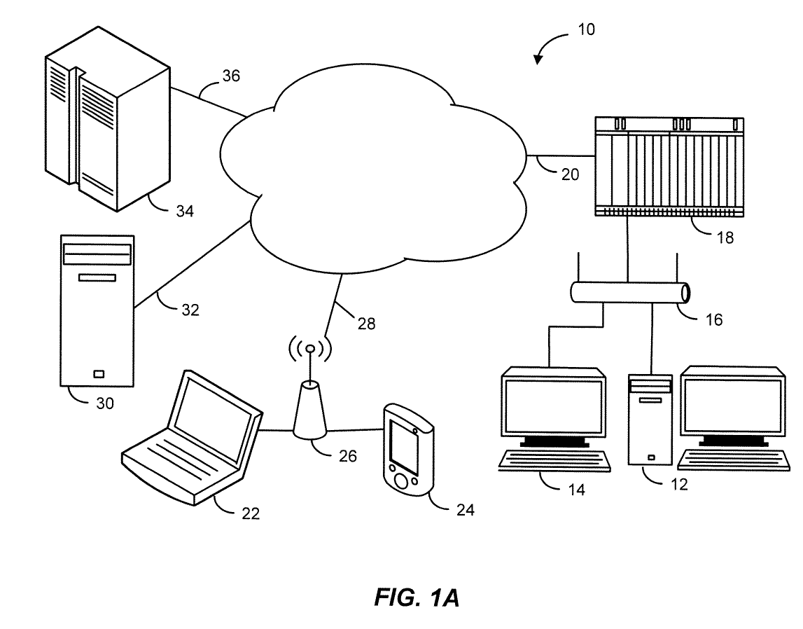

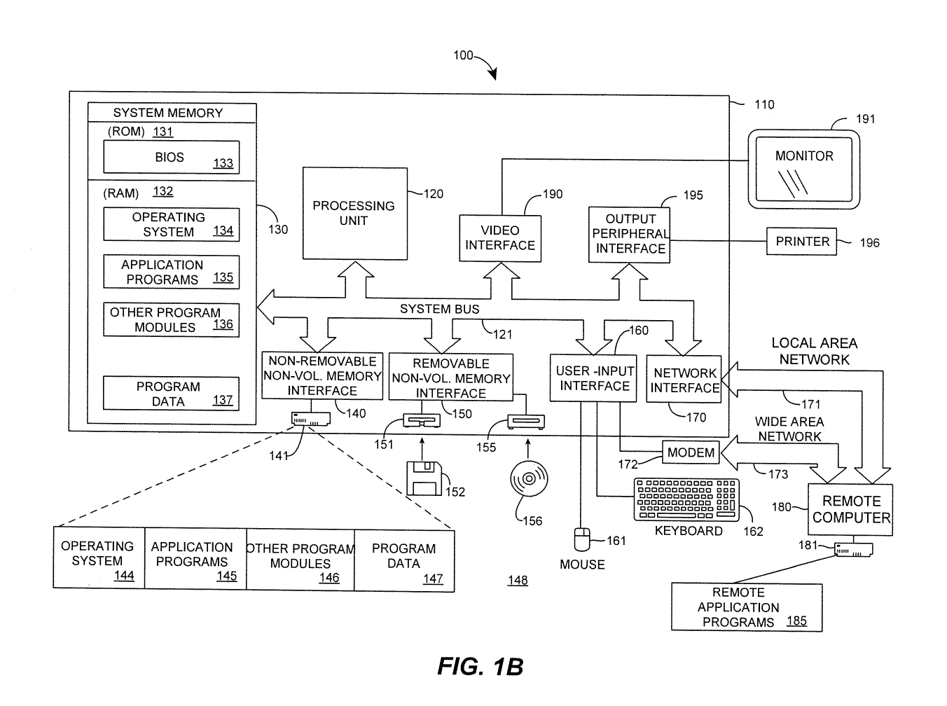

FIGS. 1A-1B provide a structural basis for the network and computational platforms related to the instant disclosure.

FIG. 1A illustrates a network 10. The network 10 may be the Internet, a virtual private network (VPN), or any other network that allows one or more computers, communication devices, databases, etc., to be communicatively connected to each other. The network 10 may be connected to a personal computer 12, and a computer terminal 14 via an Ethernet 16 and a router 18, and a landline 20. The Ethernet 16 may be a subnet of a larger Internet Protocol network. Other networked resources, such as projectors or printers (not depicted), may also be supported via the Ethernet 16 or another data network. On the other hand, the network 10 may be wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. The network 10 may be useful for supporting peer-to-peer network traffic.

FIG. 1B illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1B illustrates operating system 134, application programs 135, other program modules 136, and program data 137.

The computer 110 may also include other removable/non-removable, volatile/nonvolatile computer storage media. By way of example only, FIG. 1B illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1B, provide storage of computer readable instructions, data structures, program modules and other data for the computer 110. In FIG. 1B, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. These and other input devices are often connected to the processing unit 120 through an input interface 160 that is coupled to the system bus, but may be connected by other interface and bus structures, such as a parallel port, or a universal serial bus (USB). A monitor 191 or other type of display device is also connected to the system bus 121 via an interface, such as a graphics controller 190. In addition to the monitor, computers may also include other peripheral output devices such as a printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1B. The logical connections depicted in FIG. 1B include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 1B illustrates remote application programs 185 as residing on memory device 181.

The communications connections 170, 172 allow the device to communicate with other devices. The communications connections 170, 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

### MBS Processing System Overview

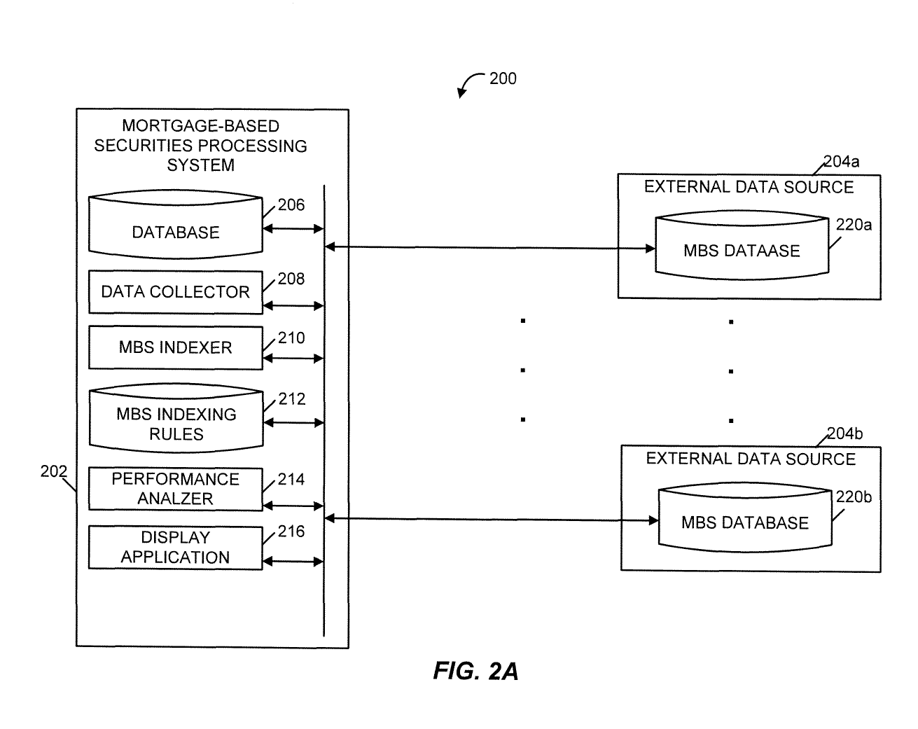

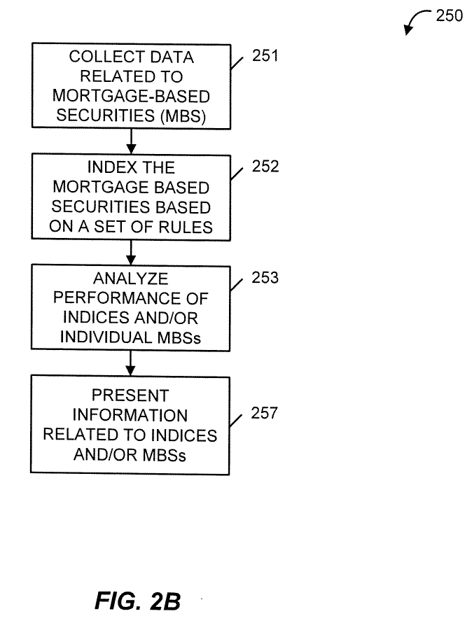

FIG. 2A illustrates an example mortgage-backed security (MBS) processing environment 200. Systems described in reference to FIG. 2 may be coupled to a network similar to the network 10 described in FIG. 1A. The systems described in reference to FIG. 2 may further include and/or be implemented on one or more computers similar to the computer 110 described in FIG. 1B.

Referring to FIG. 2A, the MBS processing environment 200 may include an MBS processing system 202 that generally processes mortgage-backed securities. More specifically, referring to FIG. 2B, the MBS processing system 202 may be configured to collect and, aggregate, organize and categorize data related to various MBSs (block 251), index the MBSs based on a set of rules (block 252), analyze the performance of the MBS indices and/or of the individual MBSs (block 253), and present information related to MBS indices and/or the individual MBSs (e.g., one a screen, such as monitor 191) to a user (block 257). Moreover, the MBS processing system 202 may be configured to repeat some or all of these functions. For example, the MBS processing system 202 may be configured to, at regular intervals (e.g., monthly, or weekly), or at the request of the user, update the collected data related to the MBSs, the indexing, and/or the performance analysis, if any such updates may be desired or required. As a result, the MBS processing system 202 may process MBSs in a dynamic and/or adaptive fashion. These and various other aspects of the MBS processing system 202 will be subsequently described in more detail.

Referring again to FIG. 2A, in order to collect and aggregate data related to various MBSs, the MBS processing system 202 may include one or more data collectors 208 to collect the data, and a database 206 to store the collected data. The data collectors 208, or other units of the MBS processing system 202, may interact with various external data sources 204 to collect a range of data related to financial deals and/or transactions (e.g., loans) associated with various mortgage-based securities. These external data sources 204 may include MBS databases with loan-level data related to the mortgage-based securities, such as the date of issuance of that MBS, the loans included in the MBS when it issued, historical and analytic data regarding the MBS, and so on. Some examples of external data sources 204 include the mortgage securities databases provided by LoanPerformance, a subsidiary of First American Real Estate Solutions of San Francisco, Calif. and by Intex Solutions of Boston, Calif. However, it will be understood that the MBS processing system 202 described herein is not limited to any particular external data source 204.

In order to index the MBSs associated with the collected data, the MBS processing system 202 may include an MBS indexer 210. Generally speaking, the MBS indexer 210 may organize the MBSs (e.g., associated with data stored in the database, or data received/retrieved from external data sources 204) into MBS indices (also referred to as “MBS bins,” or “MBS buckets”), based on a number of meaningful categories. These categories may be captured, for example, in the MBS indexing rules 212 included in the MBS processing system 202. In some embodiments, the MBS indexing rules 212 may be dynamic and/or adaptive rules that may change with time and/or in response to new events and/or new received data. Indexing of the MBSs, the MBS indexer 210 and MBS indexing rules 212 will be subsequently described in more detail.

In order to analyze the performance of the MBS indices and/or of the individual MBSs, the MBS processing system 202 may include a performance analyzer 214. In general, the performance analyzer 214 may identify meaningful collateral attributes and/or performance variables related to MBSs and/or MBS indices and characterize the performance of these MBSs and/or MBS indices based on the determined collateral attributes and/or performance variables. For example, the performance analyzer 214 may rank different MBS indices, or different MBSs within a given MBS index, based on, for example, the performance, or estimated performance, of the associated MBSs. As a result, the performance analyzer 214 may enable a user to gauge the relative performance of a given MBS index, or of individual MBSs within that index. Performance analysis and the performance analyzer 214 will be subsequently discussed in more detail.

In order to present information regarding MBSs and/or MBS indices to a user, the MBS processing system 202 may include a display application 216. The display application may allow a user to view various information related to the indices and the individual MBSs, such as summaries of the different indices, distribution of collateral attributes and/or performance variable within the indices, histograms of various variables associated with the indices, or individual MBSs, time series of the evolution of various performance data, etc. Details of the display application 216 will be subsequently described in more detail.

It should be understood that the MBS processing system 202, in some embodiments, or in some modes of operation, may not include one or more of the units 206-216 or, alternatively, may not use each of the units 206-216 in processing MBSs. Further, it will be appreciated that some of the units 206-216 may be combined, or divided into distinct units.

### Indexing of MBSs

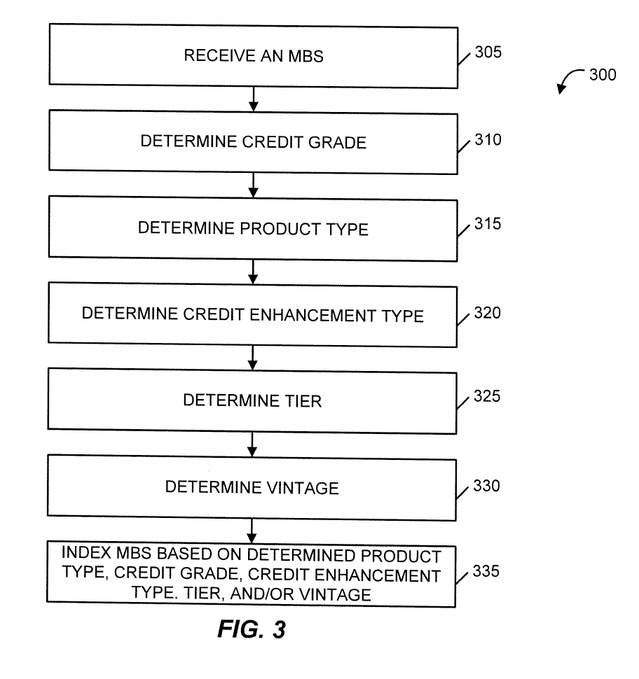

FIG. 3 is a flow diagram of an example indexing method 300. For ease of explanation, FIG. 3 will be described with reference to FIGS. 1-2A. It will be understood, however, that the indexing method 300 may be utilized with systems and devices other than those illustrated in FIGS. 1-2A.

As explained in reference to FIGS. 2A-2B, data related to different MBSs may be received at, or collected by, an MBS processing system, such as the MBS processing system 202 (block 305) and, optionally, stored on the MBS processing system (e.g., in a database). The MBS may then be associated with an appropriate bin (or a bucket, or and index), based on the data associated with the received MBS.

In some embodiments, the credit grade of the borrower, or borrowers associated with the MBS may be determined (block 310) for the purpose of indexing. The credit grade is generally related to the category of borrowers, and such categories may include Prime, Alt-A, and Subprime borrowers. Prime borrowers are generally those borrowers that have relatively high credit scores, and subprime borrowers typically have lower credit scores. The credit scores of Alt-A borrowers normally fall between the those of prime and subprime borrowers.

Additionally, or alternatively, in some embodiments, the product type of the MBS may be determined (block 315) as one meaningful category. The product of an MBS is generally related to the underlying type of the mortgage associated with the MBS. Example product types include fixed-rate MBSs, adjustable-rate and hybrids (“ARM”) MBSs, and option arm MBSs. As the names suggest, a fixed rate MBS will typically have a fixed coupon that does not change over time (e.g., 5.5%), while an ARM MBS will typically have a floating rate coupon that is determined based upon the movement of some underlying index (e.g., 1 mo. LIBOR) plus a margin (e.g., 275 bps).

Furthermore, in order to index an MBS, the credit enhancement type associated with the MBS may be determined (block 320). Credit enhancement types are generally related to the deal structures of the MBSs. Examples of credit enhancement types include over-collateralization (“OC”) and shifting interest (“SS”), the latter also referred to as a junior/senior structure. At a high level, the collateral balance in an OC deal structure exceeds the bond balance, whereas in the SS deal structure, the collateral and bond balances exist on a one-to-one ratio.

Additionally, or alternatively, in some embodiments, a tier may be determined for the received MBS (block 325). In general, these tiers, which may be 1 through 3, capture the dispersion in underwriting and credit-collateral quality between loans securitized as Alt-A deals.

Still further, the vintage of the received MBS may be determined (block 330). There are various ways of determining the vintage of an MBS. For example, the age of the loans associated with the MBS may be determined. Alternatively, or in addition, the age of the loans at the time of the issuance of the MBS, or simply the date of issuance of the loans (e.g., first half of 2007, second half of 2008, etc.) may be determined.

It should be noted that because, as explained above, a given MBS will include multiple loans, the different loans associated with a single MBS may have some attributes (e.g., credit grade, vintage, etc.) that vary from loan to loan. In such a case, a weighted average of the respective attribute associated with each loan, e.g., the date of issuance, may be calculated as an approximation of the attribute in question.

Once one or more of the parameters discussed above are determined, the MBS may be indexed based on at least one, but likely more than one, of those parameters (block 335). That is, the MBS may be associated with an appropriate MBS index based on those parameters. In some embodiments, individual MBSs may be associated with appropriate MBS indices based on a set of MBS indexing rules (such as the MBS indexing rules 212 discussed in reference to FIG. 2A). Generally speaking, the MBS indexing rules may provide a mapping between different sets of parameters determined in blocks 305-335 and different MBS indices. In other words, the MBS rules may specify how to determine an appropriate MBS index for an MBS with given set of parameters.

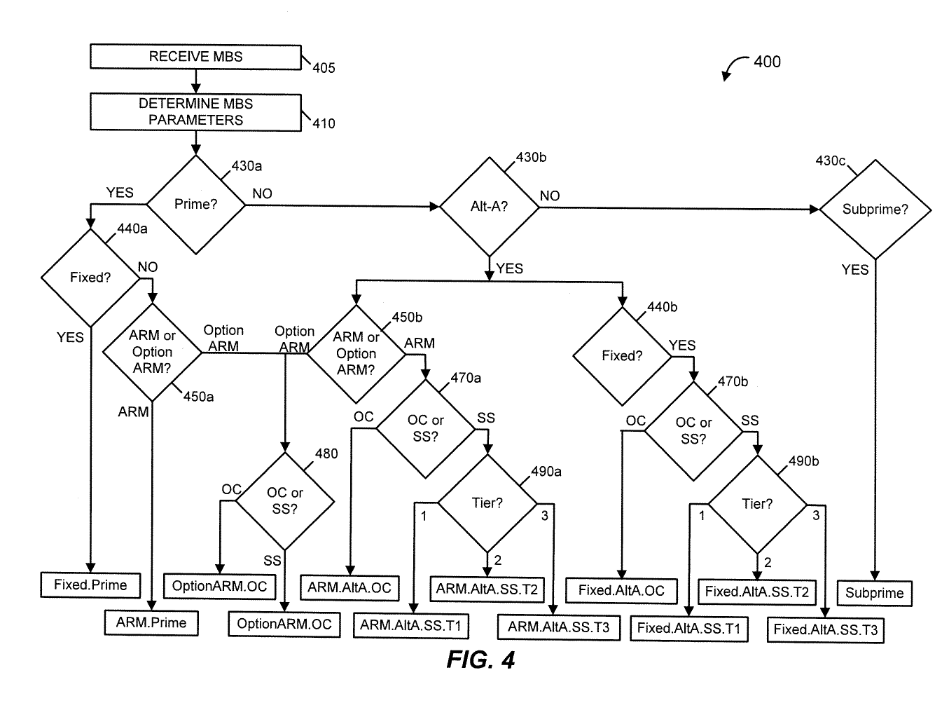

FIG. 4 is a flow diagram illustrating example MBS indexing rules 400. For ease of explanation, FIG. 4 will be described with reference to FIGS. 1-2A. It will be understood, however, that the MBS indexing rules 400 may be utilized with systems and devices other than those illustrated in FIGS. 1-2A.

Referring to FIG. 4, when data related to various MBSs is received at, or collected by an MBS processing system, such as the MBS processing system 202 (block 405), various parameters of the MBSs may be determined (block 410), as discussed, for example, in reference to FIG. 3. Based on these parameters, the MBSs may be associated with appropriate MBS indices based on the following example MBS indexing rules.

In some embodiments, the MBSs may first be divided into different groups based on credit type, e.g., prime, Alt-A, or subprime (blocks 430). Then, the MBSs that are in the prime an Alt-A groups may be further divided into different subgroups groups based on product type, e.g., fixed rate (blocks 440), ARM and option ARM (blocks 450). Those MBSs that are determined to have a credit grade of Alt-A may be divided still further into different subgroups based on the credit enhancements of the MBS, including a subgroup with OC credit enhancement and a subgroup with SS credit enhancement (blocks 470). Additionally, those MBSs that have an SS credit enhancement type, (“YES” branches of blocks 470) may further be divided into tiers, e.g., as described in reference to FIG. 2B (blocks 490). Those MBSs that are determined to be option arm MBSs (“Option ARM” branches of blocks 450) may simply be divided into groups based on credit enhancement type (irrespective of other parameters), including a group associated with OC credit enhancement type and a group associated with SS credit enhancement type (block 480).

Using the example MBS indexing rules 400 illustrated in FIG. 4, the received MBSs may ultimately be placed in one of thirteen MBS indices or bins: ARM.Prime, ARM.AltA.OC, ARM.AltA.SS.T1, ARM.AltA.SS.T2, ARM.AltA.SS.T3, Fixed.Prime, Fixed.AltA.OC, Fixed.AltA.SS.T1, Fixed.AltA.SS.T2, Fixed.AltA.SS.T3, OptionARM.OC, OptionARM.SS, and Subprime. As a result, as MBSs are received, or retrieved, some or all of these different bins may fill up to form distinct MBS indices. Data regarding these bins (e.g., attributes of the bins, MBSs associated with the bin, and so on) may be stored in a variety of ways. For example, this data may be stored in a database of the MBS processing system, such as the MBS processing system 202 in FIG. 2A, on a remote server, etc.

It will be appreciated by one of ordinary skill in the art that the example MBS indexing rules may be modified in a variety of ways without straying away from the scope of this disclosure. For example, the illustrated grouping may be performed in a different order (e.g., grouping by product type before group grouping by credit grade). Furthermore, other grouping may be performed based on additional characteristics of the MBSs. For example, the MBSs may further be group based on the vintage of the associated loans, as discussed, for instance, in reference to FIG. 3. In some embodiments, the MBSs may be further subdivided based on the vintage of the associated loans in six-month increments (e.g., first half of 2006, second half of 2007, and so on).

It will be understood that MBS indexing rules, such as the example MBS indexing rules 400 illustrated in FIG. 4 may be dynamic and/or adaptive. That is, MBS indexing rules may change with time, or in response to new data. For instance, in the example illustrated in FIG. 4, the ARM MBSs are bifurcated based on credit grade, but the option arm MBSs are not. However, if it is determined, at some point, that such a bifurcation would be meaningful for option arm MBSs, the MBS indexing rules may be changed.

The MBS indexing rules may be changed in a number of ways. In some embodiments, the MBS indexing rules may be changed by a user. Additionally, or alternatively, the MBS indexing rules may be changed automatically. For example, statistical modeling tools, such as an artificial neural network, may be used to adapt the MBS indexing rules in response to new data in order to reflect meaningful patterns in the data.

Similarly to data regarding different MBS indices themselves, data related to MBS indexing rules may be stored in a variety of ways. For example, this data may be stored in a database of the MBS processing system, such as the MBS processing system 202 in FIG. 2A, on a remote server, etc.

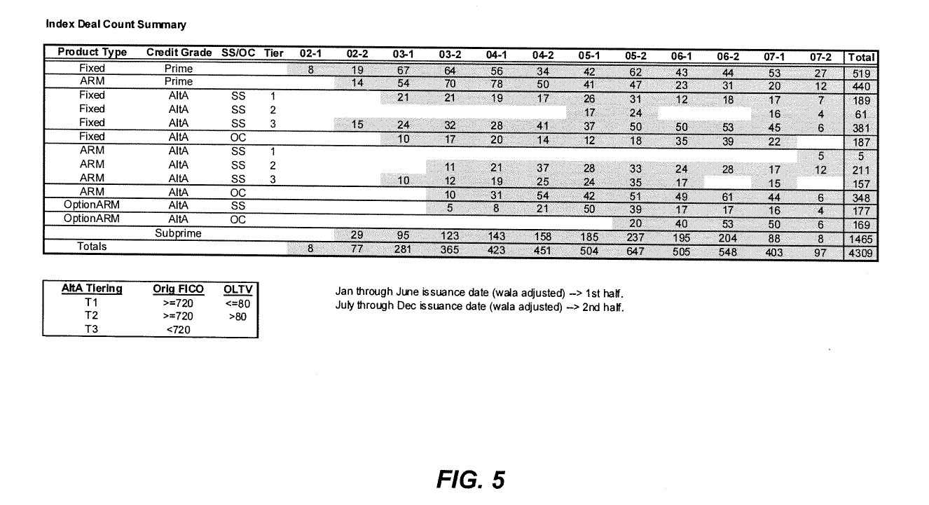

FIG. 5 illustrates an example summary of MBS indices that may be created after processing 4309 example MBSs in accordance with the MBS processing techniques described above. In the example illustrated in FIG. 5, there are 26 fixed-rate Alt-A MBSs with shifting interest in tier 1, where that associated loans were issued, on average, in the first half of 2005. Similarly, there are 28 ARM Alt-A MBSs with shifting interest in tier 2. Such indexing of MBSs provides numerous advantages. First, such MBS indexing provides a user with an intuitive overview of the population of MBSs and allows the user to identify, for example, that fixed-rate prime MGSs were the most common types of MBSs in the second half of 2007. Additionally, this MBS indexing enables a user to track different categories of MBSs and evaluate their performance, as will be subsequently described. Further, this MBS indexing enables a user to benchmark individual MBSs against the universe of MBSs captured in FIG. 5. As a result, this indexing enables a user to compare how individual MBSs perform against other MBSs in the same or similar categories.

### Performance Analysis

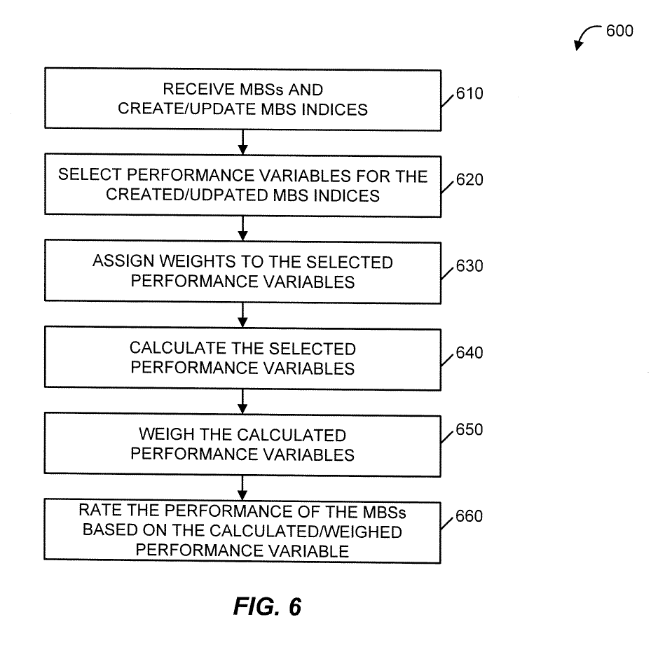

FIG. 6 is a flow diagram of an example index performance analysis method 600. For ease of explanation, FIG. 6 will be described with reference to FIGS. 1-2A. It will be understood, however, that the performance analysis method 600 may be utilized with systems and devices other than those illustrated in FIGS. 1-2A.

When data related to multiple MBSs is received at, or collected by an MBS processing system, such as the MBS processing system 202, and MBS indices are created, or updated (block 610), various performance variables may be selected to analyze the performance of the MBS indices (block 620). These performance variables may be selected in a variety of ways. For example, some performance variables may simply be raw attributes of the MBSs received from one or more external data source, such those illustrated in FIG. 2A. Other performance variables may be based on various (e.g., mathematical) combinations of the raw attributes. While some performance variables may be themselves indicative of the performance of the MBS index, other performance variables may be indicative of performance only in combination with other performance variables.

There may be a wide range of possible performance variables. Some basic performance variables may include the weighted average coupon (WAC) and weighted average loan age (WALA) associated with the MBSs in a given MBS index. Other performance variables include average balance, average loan size, average weighted average original FICO, etc., associated with the MBSs in a given MBS index. Additionally, some performance variables may be indicative of the amortization of the loans associated with an MBS index from origination to date (zip codes may be used to estimate the change in property values). Other performance variables may include, for example, the percentage of loans in a given MBS index that are past the 60-day delinquency period (also known as “60+ day delinquency”, the percentage of loans that are either in foreclosure or repossessed (e.g., Real Estate Owned, or REQ), the percentage of loans that are in bankruptcy, etc. Some performance variable may further include information regarding loss severities, such as the averaged loss severity over a given period (e.g., the most recent 3 months), cumulative loss to date as a percentage of the original balance, etc. It will be appreciated by one of ordinary skill in the art that hundreds of other performance variable may be includes, such as those related to geographic concentrations, documentation types, investor property percentages, an so on. Again, these variable may include both raw attributes of the received MBSs as well as various combinations of these raw attributes.

In addition to selecting the performance variables (block 620), different weights can be assigned to different performance variables (block 630) to allocate relative importance to the different performance variables. For example, it may be determined that the percentage of loans that are in foreclosure is more important in characterizing the performance of the associated MBS or MBS index than the averaged loss severity over the past three months. In such a case, the performance variable indicative of the percentage of loans that are in foreclosure may receive a higher percentage of the overall weight than the performance variable indicative of the averaged loss severity over the past three months.

As with indexing, selection of performance variables and their weights may be preset or dynamic. Furthermore, this selection may be performed by a user, or it may be performed automatically. For example, an adaptive statistical model (e.g., an artificial neural network) may keep track of different performance variables and correlate them, for example, with the actual performance of MBSs and MBS indices to identify meaningful patterns and reflect these patterns by selecting new performance variables and weights.

Once performance variables are selected and appropriate weights are assigned, the variables may be calculated (block 640) and weighed (block 650), and the performance of MBSs within MBS indices may be rated based on these calculated and weighed performance variables (block 660). Performance of MBSs within an MBS index may be rated in a variety of ways. For example, the weighted average of the selected performance variables may itself be a performance metric. Additionally, or alternatively, the weighted average of the selected performance variables may be mapped to a different performance metric. In some embodiments, the weighted average of the selected performance variables may be mapped to a rank, e.g., from 1 to 4, where MBSs that receives a rank of 1 perform relatively well, as compared to other MBSs in the same MBS index, and the MBSs that receive a rank of 4 have a relatively poor performance. The rank itself may be indicative of various performance metrics. In some embodiments, a rank associated with a group of MBSs within a given MBS index is indicative of the expected lifetime cumulative losses associated with the MBSs in that group. However, it will be understood that other types of rankings are possible.

### Presentation of Information

Data associated with different MBSs and MBS indices, including performance data, may be presented to a user in a variety of ways to enable the user, for example, to perform further analysis of that data and/or to draw inferences based on the presented data. In some embodiments, a display application may be used to present data to the user. Details of an example display application are described below.

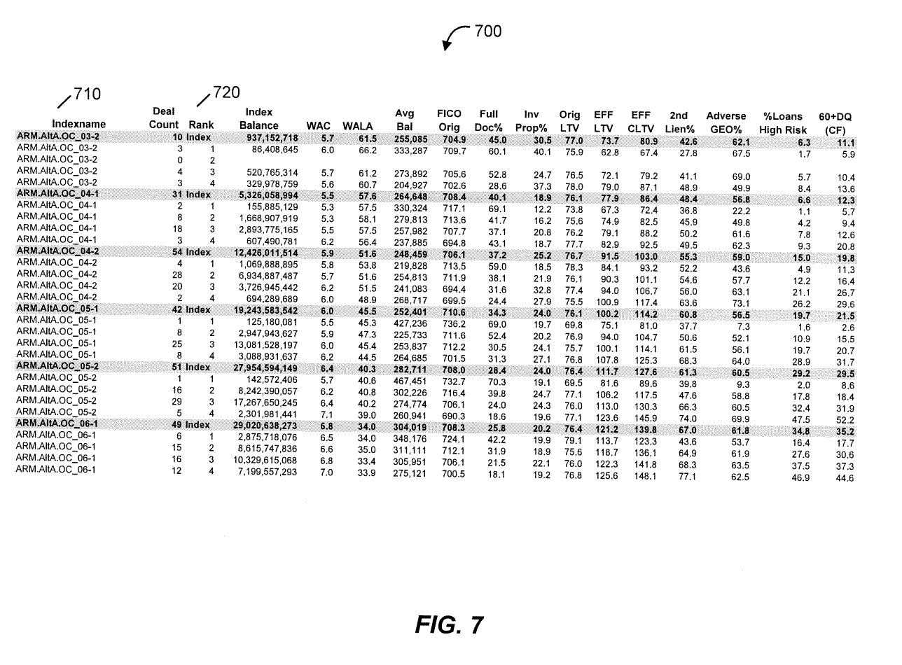

FIG. 7 illustrates an example interface 700 for presenting data regarding MBSs and MBS indices and their performance to a user. In the example illustrated in FIG. 7, a user may be presented with such data in summary form. For example, the display application may display to a user a list of individual MBS indices (6 MBS indices in FIG. 7) with the associated parameters (e.g., collateral attributes, performance variables and so on). Additionally, for each MBS index, the display application may display information regarding different ranks (e.g., 1-4) of the MBSs. For example, the MBS index ARM.AltA.OC_{—}03_{—}2 includes a total of 10 MBSs (or deals), including 3 MBSs in rank 1, no MBSs in rank 2, 4 MBSs in rank 3, and 3 MBSs in rank 4. As a result, when a new MBS is received/retrieved and indexed, a user may evaluate the performance of that MBS in relation to other MBSs in the same index.

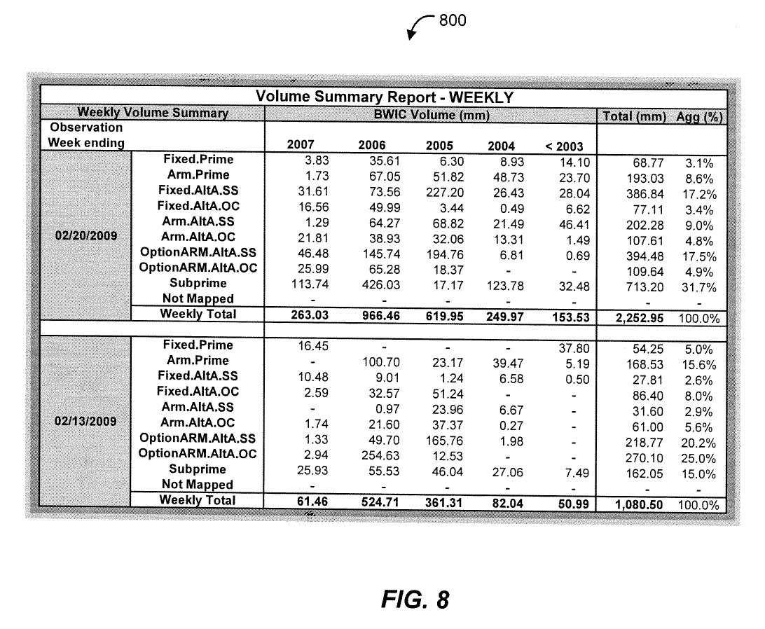

Referring to FIG. 8, the display application may also display to the user various summary reports, such as a weekly, or monthly, Bid Wanted in Competition (BWIC) report 800 grouped by MBS indices. Such reports may allow a user to see the bid activity for various types of MBSs and identify meaningful patterns. As a result, a transparency may be added to market activity, even when markets are widely perceived to be illiquid.

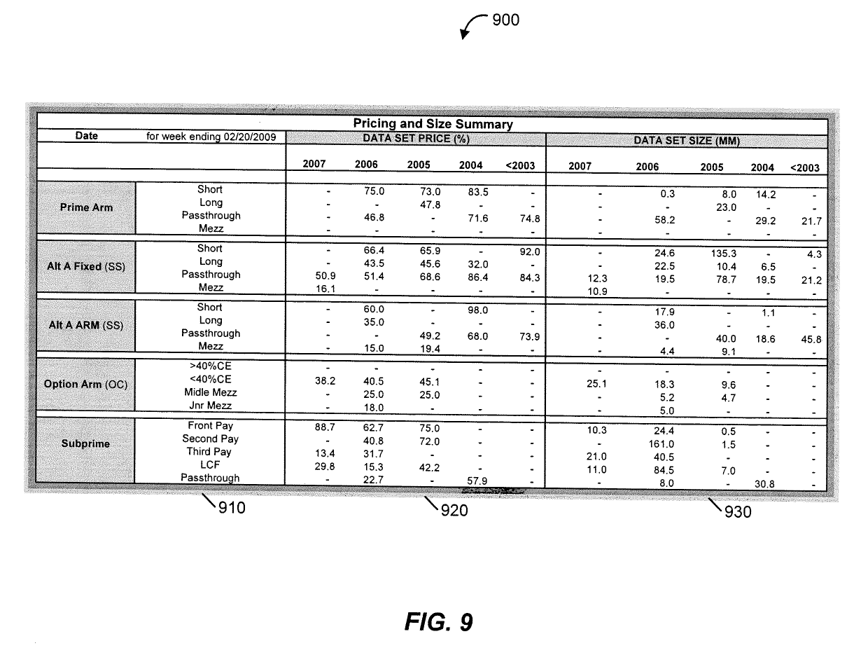

Referring to FIG. 9, the display application may also display to the user various pricing summary outputs, such as a BWIC pricing summary output 900. The BWIC pricing summary output 900 may include structure groupings 910 that are specific to the credit grade of the securitization and the associated data set price percentages 920 and the associated data set sizes 930.

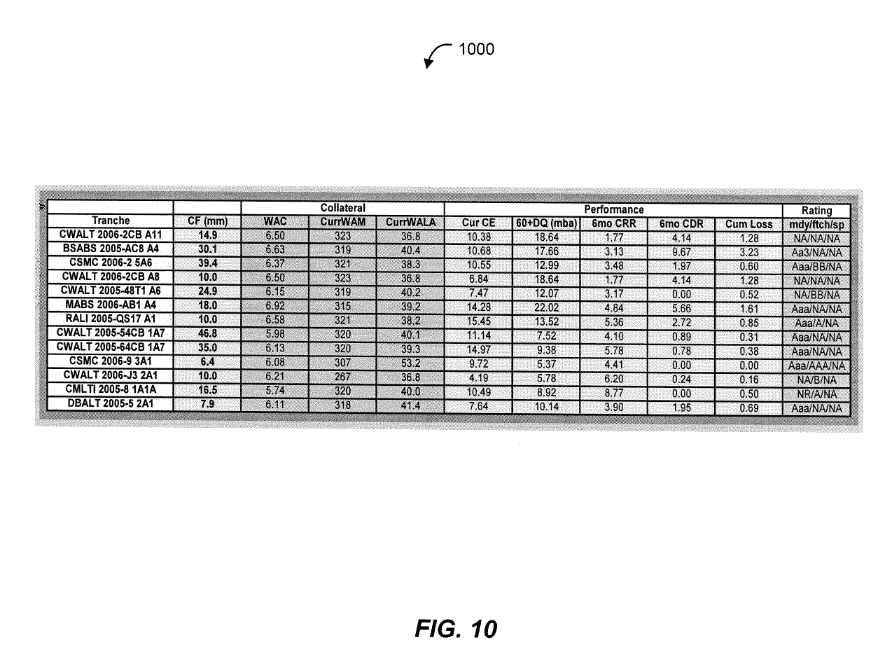

Referring to FIG. 10, the display application may further allow the user to view the details for specific bonds associated with MBSs. In some embodiments, the user may be presented with a list of bonds 1000 and the various variable (e.g., performance variables) associated with those bonds, such as WAC, WALA, cumulative loss, 60+ day delinquency, etc.

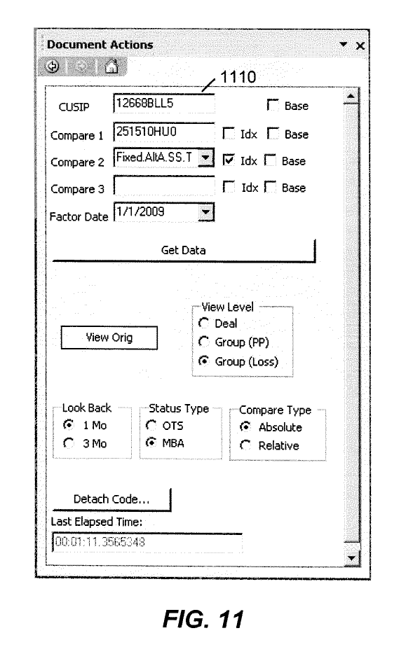

Referring to FIG. 11, in addition to displaying details of a given MBS, the display application may also pull in an MBS index associated with the MBS and compare the performance of the MBS to that of other MBSs in the associated MBS index, or with the MBS index itself. In the example illustrated in FIG. 11, for instance, two bonds “CWALT” and “DBALT” associated with different MBSs may be compared with each other and with the relevant MBS index Fixed.AltA.SS.T3_{—}05-2. In particular, the display application may help a user track the performance associated with a particular Committee on Uniform Security Identification Procedures (CUSIP) 1110, such as a CUSIP after the a bid, or a CUSIP in a portfolio, by associating the CUSIP with a particular MBS index. For example, the display application may bring up the collateral attributes and performance variables for both the CUSIP and the MBS index.

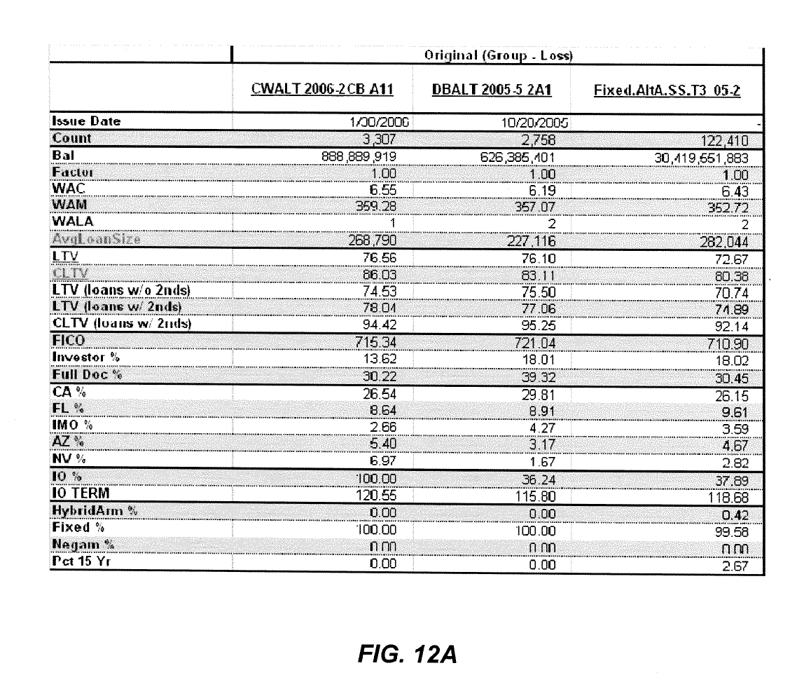

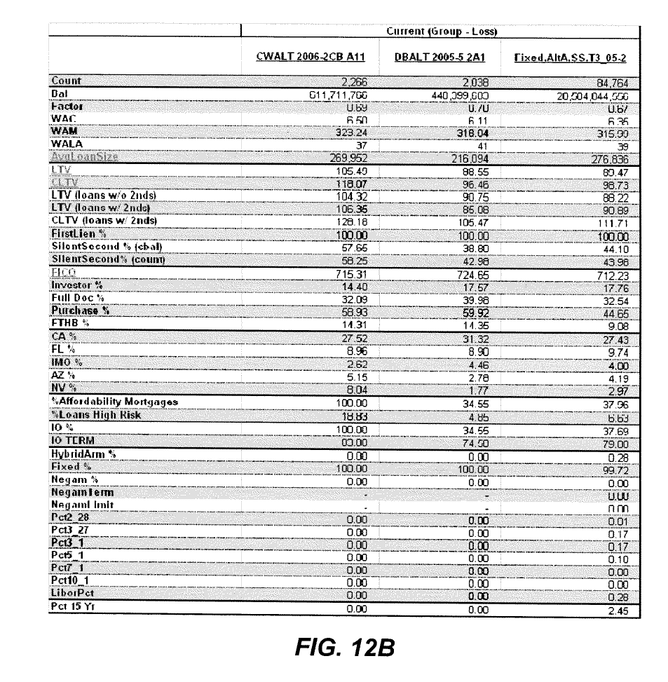

As a result, as illustrated in FIGS. 12A-12B, immediate comparison of the CUSIP in question with the related MBS index may be provided to a user. The comparison may be based on a number of factors, such as original collateral information (and the original LTV), as illustrated in FIG. 12A, current collateral information (and the effective LTV), as illustrated in FIG. 12B, etc. The display application may provide various other metrics to the user for the purpose of comparison, including “silent second” information (including the percentage of loans in an MBS that have second liens and information regarding potentially self-serving, or perhaps fraudulent, schemes where house sellers accept second mortgages as part of a sale transaction, without the full knowledge of the first mortgage lender). Based on this comparison, a user may be able to determine, for example, how well a given MBS performs relative to other MBSs of a similar type. Accordingly, a relatively expedient benchmarking is provided by instantaneous reference of a CUSIP in question to the relevant MBS index.

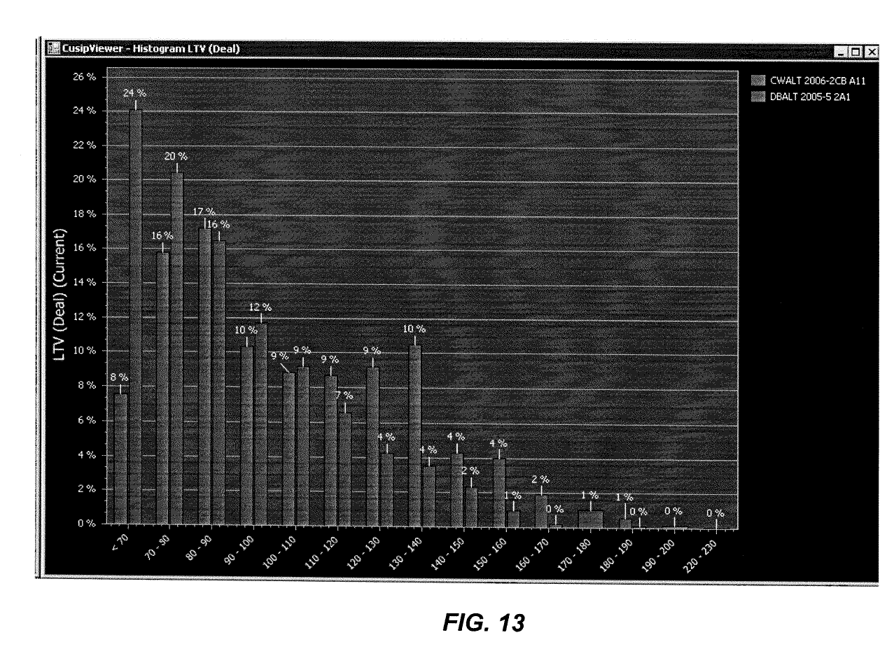

Referring to FIG. 13, the display application may display information regarding individual MBSs and MBS indices in graphical form. For example, the display application may display various histograms related to the loans associated with individual MBSs. In the example illustrated in FIG. 13, for instance, the display application displays in graphical form the percentage of loans within different ranges of effective LTV for two different MBSs, allowing a user to infer, for example, that roughly 44% of the loans backing DBALT have effective LTVs below 80, and that roughly 76% of the loans backing CWALT have effective LTVs above 80.

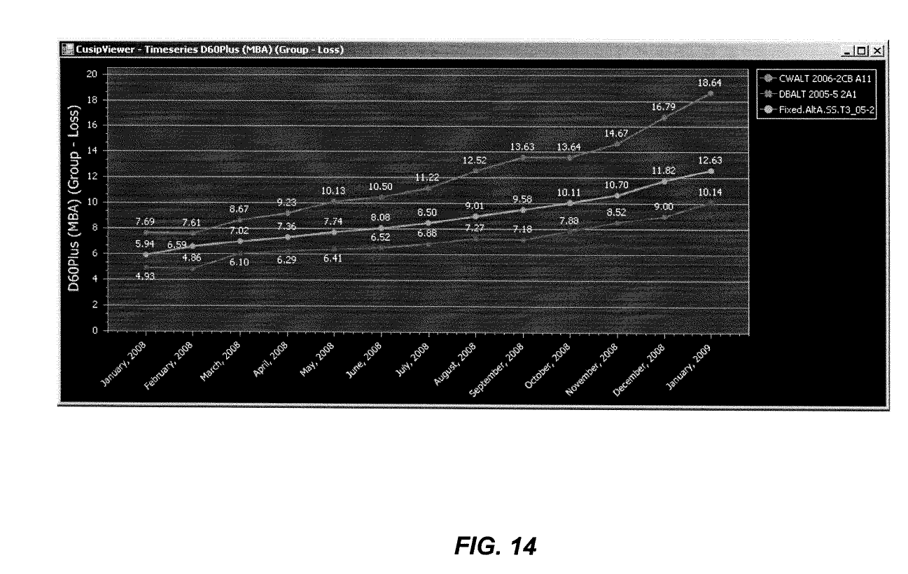

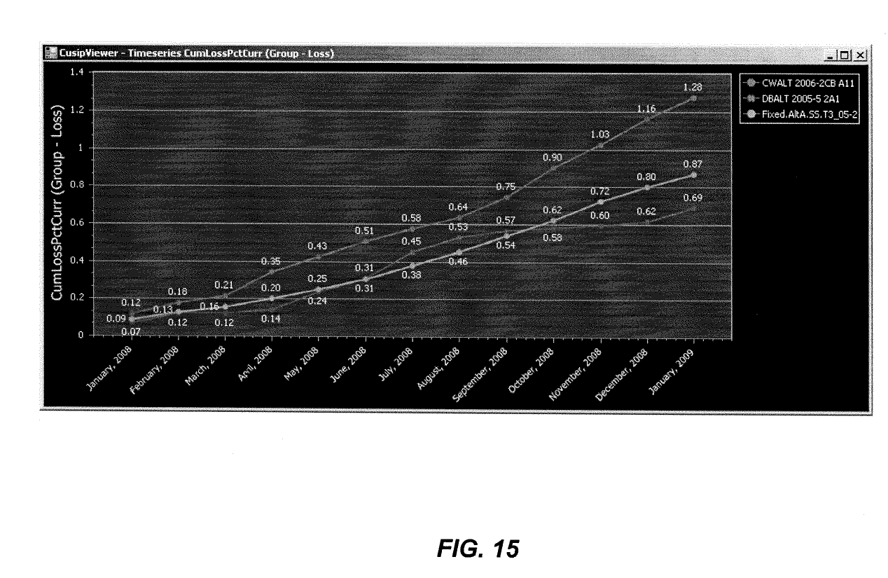

Various other performance details may be presented to the user. For example, referring to FIG. 14, the display application may display the number of 60+ day delinquencies over time associated both with individual MBSs and the corresponding MBS indices. Likewise, referring to FIG. 15, the display application may display the cumulative losses over time associated with both the individual MBSs and the corresponding MBS indices. Again, this allows a user to gauge how well different MBSs of similar type perform relative to each, in terms of 60+ day delinquencies and cumulative losses in the examples illustrated in FIGS. 14 and 15 respectively.

Although techniques for processing MBSs have been described above in terms of particular embodiments, it should be understood that the scope of the disclosure is defined by the words of the claims set forth at the end of this disclosure. The detailed description is to be construed as exemplary only and does not describe every possible embodiment because describing every possible embodiment would be impractical, if not impossible. Numerous alternative embodiments could be implemented, using either current technology or technology developed after the filing date of this disclosure, which would still fall within the scope of the claims.

1. A mortgage-backed securities (MBS) processing system comprising:
a processor;
a database configured to store data pertaining to a plurality of mortgage-backed securities, wherein each of the plurality of mortgage-backed securities is associated with at least one loan; and
a computer-readable memory that includes computer-readable instructions, wherein the computer-readable instructions, when executed on the processor, associate the plurality of mortgage-backed securities stored in the database with a plurality of different MBS indices based on a plurality of MBS indexing rules, wherein the plurality of MBS indexing rules map a given one of the plurality of mortgage-backed securities to a given one of the plurality of different MBS indices based at least in part on a credit enhancement type associated with the given one of the plurality of mortgage-backed securities.

2. The MBS processing system of claim 1, wherein the credit enhancement type associated with the given one of the plurality of mortgage-backed securities is related to a deal structure associated with the given one of the plurality of mortgage-backed securities, the deal structure selected from a group including over-collateralization deal structure or a shifting-interest deal structure.

3. The MBS processing system of claim 1, wherein the plurality of MBS indexing rules further map the given one of the plurality of mortgage-backed securities to the given one of the plurality of different MBS indices based at least in part on a credit grade associated with the given one of the plurality of mortgage-backed securities.

4. The MBS processing system of claim 3, wherein the credit grade associated with the given one of the plurality of mortgage-backed securities is related to a category of borrower associated with the given one of the plurality of mortgage-backed securities, the category of borrower selected from a group comprising Prime borrower, Alternative A-paper (Alt-A) borrower, or Subprime borrower.

5. The MBS processing system of claim 3, wherein the at least one loan comprises a plurality of loans, and wherein the credit grade is a weighted average of credit grades associated with the plurality of loans.

6. The MBS processing system of claim 1, wherein the plurality of MBS indexing rules further map the given one of the plurality of mortgage-backed securities to the given one of the plurality of different MBS indices based at least in part on a product type associated with the given one of the plurality of mortgage-backed securities.

7. The MBS processing system of claim 6, wherein the product type associated with the given one of the plurality of mortgage-backed securities is related to an underlying type of mortgage associated with the given one of the plurality of mortgage-backed securities, the underlying type of mortgage selected from a group comprising fixed-rate mortgage-backed security, adjustable-rate mortgage-backed security, hybrid mortgage-backed security, or option ARM mortgage-backed security.

8. The MBS processing system of claim 1, wherein the plurality of MBS indexing rules further map the given one of the plurality of mortgage-backed securities to the given one of the plurality of different MBS indices based at least in part on a vintage associated with the given one of the plurality of mortgage-backed securities.

9. The MBS processing system of claim 8, wherein the at least one loan comprises a plurality of loans, and wherein the vintage associated with the given one of the plurality of mortgage-backed securities is related to ages of the plurality of loans.

10. The MBS processing system of claim 8, wherein the at least one loan comprises a plurality of loans, and wherein the vintage associated with the given one of the plurality of mortgage-backed securities is related to dates of issuance of the plurality of loans.

11. The MBS processing system of claim 1, wherein the plurality of MBS indexing rules further map the given one of the plurality of mortgage-backed securities to the given one of the plurality of different MBS indices based at least in part on a dispersion in underwriting and credit-collateral associated with the given one of the plurality of mortgage-backed securities.

12. The MBS processing system of claim 1, wherein at least some of the plurality of MBS indexing rules change automatically with time.

13. The MBS processing system of claim 1, wherein at least some of the plurality of MBS indexing rules change automatically in response to new data.

14. The MBS processing system of claim 1, wherein at least some of the plurality of MBS indexing rules may be changed by a user.

15. The MBS processing system of claim 1, wherein the computer-readable memory further includes instructions that, when executed on the processor, determine a measure of performance for each of the plurality of different MBS indices.

16. The MBS processing system of claim 15, wherein the instructions that determine the measure of performance rank the performance of the plurality of different MBS indices relative to each other.

17. The MBS processing system of claim 15, wherein the instructions that determine the measure of performance determine, for a given one of the plurality of different MBS indices, a measure of performance for individual mortgage-backed securities associated with the given one of the plurality of different MBS indices.

18. The MBS processing system of claim 1, further comprising a display application configured to provide information related to the plurality of different MBS indices to a user.

19. The MBS processing system of claim 18, wherein the display application is configured to provide information related to a performance of at least one of the plurality of different MBS indices.

20. The MBS processing system of claim 18, wherein the display application is configured to provide information related to a rank associated with each one of the plurality of different MBS indices.

21. A mortgage-backed securities (MBS) processing system comprising:
a processor;
a database configured to store data pertaining to a plurality of mortgage-backed securities, wherein each of the plurality of mortgage-backed securities is associated with at least one loan; and
a computer-readable memory having computer-readable instructions, wherein the computer-readable instructions are configured to execute on the processor to:
associate the mortgage-backed securities in the plurality of mortgage-backed securities stored in the database with a plurality of different MBS indices based on a plurality of MBS indexing rules; and
determine a measure of performance for each of the plurality of different MBS indices.

22. The MBS processing system of claim 21, wherein to determine a measure of performance for one of the plurality of different MBS indices, the computer-readable instructions are further configured to execute on the processor to:
select a plurality of performance variables that are indicative of the performance of the one of the plurality of different MBS indices;
assign a weight to each of the selected plurality of performance variables, wherein the weight assigned to a given one of the plurality of performance variables is indicative of an importance of the given one of the plurality of performance variables in determining the measure of performance for the one of the plurality of different MBS indices;
calculate values of the selected plurality of performance variables;
weigh the calculated values based on the respective assigned weights by multiplying the respective calculated values by the respective assigned weights; and
determine the measure of performance for the one of the plurality of different MBS indices based on the weighted, calculated values.

23. The MBS processing system of claim 22, wherein the plurality of performance variables are selected from a group comprising:
a weighted average coupon of the at least one loan associated with the one of the plurality of different MBS indices;
a weighted average age of the at least one loan associated with the one of the plurality of different MBS indices;
an average balance of the at least one loan associated with the one of the plurality of different MBS indices;
an average loan size of the at least one loan associated with the one of the plurality of different MBS indices;
a percentage of the at least one loan associated with the one of the plurality of different MBS indices that are past the 60-day delinquency period;
a percentage of the at least one loan associated with the one of the plurality of different MBS indices that are in foreclosure;
a percentage of the at least one loan associated with the one of the plurality of different MBS indices that are repossessed;
a percentage of the at least one loan associated with the one of the plurality of different MBS indices that are in bankruptcy; or
loss severity associated with the one of the plurality of different MBS indices.

24. The MBS processing system of claim 21, wherein to determine the measure of performance for each of the plurality of different MBS indices the computer-readable instructions are configured to rank performance of the plurality of different MBS indices relative to each other.

25. The MBS processing system of claim 21, wherein to determine the measure of performance for one of the plurality of different MBS indices, the computer-readable instructions are further configured to determine a measure of performance for individual mortgage-backed securities associated with the given one of the plurality of different MBS indices.

26. A method for use with a mortgage-backed securities (MBS) processing system, the MBS processing system having a database, a processor and a memory, the memory storing computer-readable instructions that are executable on the processor, the method comprising:
receiving data pertaining to a plurality of mortgage-backed securities, wherein each of the plurality of mortgage-backed securities is associated with at least one loan;
associating, in the database, the mortgage-backed securities in the plurality of mortgage-backed securities with a plurality of different MBS indices based on a plurality of MBS indexing rules, wherein the plurality of MBS indexing rules map a given one of the plurality of mortgage-backed securities to a given one of the plurality of different MBS indices based at least in part on a credit enhancement type associated with the given one of the plurality of mortgage-backed securities and related to a deal structure associated with the given one of the plurality of mortgage-backed securities;
selecting a plurality of performance variables that are indicative of the performance of any one of the plurality of different MBS indices;
assigning a weight to each of the selected plurality of performance variables, wherein the weight assigned to a given one of the plurality of performance variables is indicative of an importance of the given one of the plurality of performance variables in determining the measure of performance for any one of the plurality of different MBS indices;
calculating values of the selected plurality of performance variables;
weighing the calculated values based on the respective assigned weights by multiplying the respective calculated values by the respective assigned weights; and
determining a measure of performance for each of the plurality of different MBS indices based on the weighted, calculated values.

27. The method of claim 26, wherein selecting the plurality of performance variables that are indicative of the performance of any one of the plurality of different MBS indices comprising selecting at two or more performance variables from a group comprising:
a weighted average coupon of the at least one loan associated with the one of the plurality of different MBS indices;
a weighted average age of the at least one loan associated with the one of the plurality of different MBS indices;
an average balance of the at least one loan associated with the one of the plurality of different MBS indices;
an average loan size of the at least one loan associated with the one of the plurality of different MBS indices;
a percentage of the at least one loan associated with the one of the plurality of different MBS indices that are past the 60-day delinquency period;
a percentage of the at least one loan associated with the one of the plurality of different MBS indices that are in foreclosure;
a percentage of the at least one loan associated with the one of the plurality of different MBS indices that are repossessed;
a percentage of the at least one loan associated with the one of the plurality of different MBS indices that are in bankruptcy; or
loss severity associated with the one of the plurality of different MBS indices.

28. The method of claim 26, wherein determining the measure of performance for each of the plurality of different MBS indices based on the weighted, calculated values comprises ranking performance of the plurality of different MBS indices relative to each other based on the weighted, calculated values.

29. The method of claim 26, wherein determining the measure of performance for each of the plurality of different MBS indices based on the weighted, calculated values comprises determining a measure of performance for individual mortgage-backed securities associated with the given one of the plurality of different MBS indices based on the weighted, calculated values.

30. A computer-readable medium recording therein a mortgage-backed securities (MBS) processing program that, when executed on a processor, causes a computer to execute a process comprising:
receiving data pertaining to a plurality of mortgage-backed securities, wherein each of the plurality of mortgage-backed securities is associated with at least one loan;
associating, in a database, the mortgage-backed securities in the plurality of mortgage-backed securities with a plurality of different MBS indices based on a plurality of MBS indexing rules;
selecting a plurality of performance variables that are indicative of a performance of any one of the plurality of different MBS indices;
assigning a weight to each of the plurality of performance variables, wherein the weight assigned to a given one of the plurality of performance variables is indicative of an importance of the given one of the plurality of performance variables in determining the measure of performance for any one of the plurality of different MBS indices;
calculating values of the selected plurality of performance variables;
using the processor to weigh the calculated values based on the respective assigned weights by multiplying the respective calculated values by the respective assigned weights; and
using the processor to determine the measure of performance for each of the plurality of different MBS indices based on the weighted, calculated values.

31. The computer-readable medium of claim 30, wherein the plurality of MBS indexing rules map a given one of the plurality of mortgage-backed securities to a given one of the plurality of different MBS indices based at least in part on one of:
a credit enhancement type associated with the given one of the plurality of mortgage-backed securities and related to a deal structure associated with the given one of the plurality of mortgage-backed securities;
a credit grade associated with the given one of the plurality of mortgage-backed securities and related to a category of borrower associated with the given one of the plurality of mortgage-backed securities;
a product type associated with the given one of the plurality of mortgage-backed securities and related to an underlying type of mortgage associated with the given one of the plurality of mortgage-backed securities;
a vintage associated with the given one of the plurality of mortgage-backed securities; or
a dispersion in underwriting and credit-collateral associated with the given one of the plurality of mortgage-backed securities.

32. A method for use in a mortgage-backed securities (MBS) processing system having a processor and a computer-readable memory, the computer-readable memory having instructions that are executable on the processor, the method comprising:
using the processor to receive data pertaining to a first plurality of mortgage-backed securities, wherein each of the plurality of mortgage-backed securities is associated with at least one loan;
using the processor to determine a plurality of MBS indexing rules for associating the mortgage-backed securities in the first plurality of mortgage-backed securities with a plurality of different MBS indices, wherein the plurality of MBS indexing rules map the plurality of mortgage-backed securities to the plurality of different MBS indices based at least in part on a first set of factors;
using the processor to associate the mortgage-backed securities in the first plurality of mortgage-backed securities with the plurality of different MBS indices based on the determined plurality of MBS indexing rules;
using the processor to receive data pertaining to a second plurality of mortgage-backed securities, wherein each of the plurality of mortgage-backed securities is associated with at least one loan; and
using the processor to modify the plurality of MBS indexing rules in response to the data pertaining to the second plurality of mortgage-backed securities, wherein the modified plurality of MBS indexing rules map the plurality of mortgage-backed securities to the plurality of different MBS indices based at least in part on a second set of factors that is different from the first set of factors;
wherein the first set of factors and the second set of factors are selected from a group including:
a credit enhancement type associated with each of the plurality of mortgage-backed securities and related to a deal structure associated with each of the plurality of mortgage-backed securities;
a credit grade associated with each of the plurality of mortgage-backed securities and related to a category of borrower associated with each of the plurality of mortgage-backed securities;
a product type associated with each of the plurality of mortgage-backed securities and related to an underlying type of mortgage associated with each of the plurality of mortgage-backed securities;
a vintage associated with each of the plurality of mortgage-backed securities; or
a dispersion in underwriting and credit-collateral associated with each of the plurality of mortgage-backed securities.

33. A computer-readable medium recording therein a mortgage-backed securities (MBS) processing program that, when executed on a processor, causes a computer to execute a process comprising:
receiving data pertaining to a first plurality of mortgage-backed securities, wherein each of the first plurality of mortgage-backed securities is associated with at least one loan;
determining a plurality of MBS indexing rules for associating the mortgage-backed securities in the first plurality of mortgage-backed securities with a plurality of different MBS indices;
associating the mortgage-backed securities in the first plurality of mortgage-backed securities with the plurality of different MBS indices based on the determined plurality of MBS indexing rules;
selecting a first plurality of performance variables that are indicative of a performance of one of the plurality of different MBS indices;
determining a first measure of performance for the one of the plurality of different MBS indices based on the selected first plurality of performance variables;
receiving data pertaining to a second plurality of mortgage-backed securities, wherein each of the second plurality of mortgage-backed securities is associated with at least one loan;
selecting, in response to the received data pertaining to the second plurality of mortgage-backed securities, a second plurality of performance variables that are indicative of the performance of the one of the plurality of different MBS indices, wherein the second plurality of performance variables is different from the first plurality of performance variables; and
determining a second measure of performance for the one of the plurality of different MBS indices based on the selected second plurality of performance variables.

34. The computer-readable medium of claim 33, wherein the first plurality of performance variables and the second plurality of performance variables include at least one of:
a weighted average coupon of the at least one loan associated with the one of the plurality of different MBS indices;
a weighted average age of the at least one loan associated with the one of the plurality of different MBS indices;
an average balance of the at least one loan associated with the one of the plurality of different MBS indices;
an average loan size of the at least one loan associated with the one of the plurality of different MBS indices;
a percentage of the at least one loan associated with the one of the plurality of different MBS indices that are past the 60-day delinquency period;
a percentage of the at least one loan associated with the one of the plurality of different MBS indices that are in foreclosure;
a percentage of the at least one loan associated with the one of the plurality of different MBS indices that are repossessed;
a percentage of the at least one loan associated with the one of the plurality of different MBS indices that are in bankruptcy; or
loss severity associated with the one of the plurality of different MBS indices.

35. The computer-readable medium of claim 33, wherein the plurality of MBS indexing rules map a given one of the received first plurality of mortgage-backed securities to a given one of the plurality of different MBS indices based at least in part on one of:
a credit enhancement type associated with the given one of the first plurality of mortgage-backed securities and related to a deal structure associated with the given one of the first plurality of mortgage-backed securities;
a credit grade associated with the given one of the first plurality of mortgage-backed securities and related to a category of borrower associated with the given one of the first plurality of mortgage-backed securities;
a product type associated with the given one of the first plurality of mortgage-backed securities and related to an underlying type of mortgage associated with the given one of the first plurality of mortgage-backed securities;
a vintage associated with the given one of the first plurality of mortgage-backed securities; or
a dispersion in underwriting and credit-collateral associated with the given one of the first plurality of mortgage-backed securities.
